(19) United States
(12) Patent Application Publication
(10) Pub. No.: US 2016/0132967 A1
(43) Pub. Date: May 12, 2016

(54) DEVICE, METHOD AND SYSTEM OF AUTOMATICALLY DEFINING A FINANCIAL INSTRUMENT

(71) Applicant: SUPER DERIVATIVES, INC., NEW YORK, NY (US)

(72) Inventors: David Gershon, Tel Aviv (IL); Omer Zaafrany, Tel Aviv (IL); Charles Marciano, Be'er Sheva (IL); Adam Shaked Gish, Hod HaSharon (IL)

(21) Appl. No.: 14/850,627

(22) Filed: Sep. 10, 2015

Related U.S. Application Data
(63) Continuation of application No. 13/878,567, filed on Jul. 8, 2013, now abandoned.
(60) Provisional application No. 61/391,647, filed on Oct. 10, 2010.

(51) Int. Cl. G06Q 40/06; G06Q 40/04

(52) U.S. Cl. CPC G06Q 40/06; G06Q 40/04

(57) ABSTRACT

Devices, systems and methods of automatically defining financial derivative instruments. For example, a computer-based method may include receiving, by a computing device, an input sequence including a sequence of a plurality of input tokens; and based on the input sequence, defining, by the computing device, a financial derivative instrument by determining, based on the plurality of input tokens, values of a plurality of parameters configuring the financial derivative instrument.

### CROSS REFERENCE

This application claims the benefit of and priority from U.S. Provisional Patent application 61/391,647, entitled “Device, method and system of automatically defining a financial instrument”, filed Oct. 10, 2010, the entire disclosure of which is incorporated herein by reference.

### FIELD

The disclosure relates generally to financial instruments and, more specifically, to device, methods and systems for automatically defining financial instruments.

### BACKGROUND

Pricing financial instruments is a complex art requiring substantial expertise and experience. Trading financial instruments, such as options, involves a sophisticated process of pricing typically performed by a trader.

The term “option” in the context of the present application is broadly defined as any financial instrument having option-like properties, e.g., any financial derivative including an option or an option-like component. This category of financial instruments may include any type of option or option-like financial instrument, relating to some underlying asset. Assets as used in this application include anything of value; tangible or non-tangible, financial or non-financial, for example, stocks; currencies; commodities, e.g., oil, metals, or sugar; interest rates; forward-rate agreements (FRA); swaps; futures; bonds; weather, e.g. the temperature at a certain area; electricity; gas emission; credit; mortgages; indices; and the like. For example, as used herein, options range from a simple Vanilla option on a single stock and up to complex convertible bonds whose convertibility depends on some key, e.g., the weather.

The term “Exchange” in the context of the present application relates to any one or more exchanges throughout the world, and includes all assets/securities, which may be traded in these exchanges. The terms “submit a price to the exchange”, “submit a quote to the exchange”, and the like generally refer to actions that a trader may perform to submit a bid and/or offer prices for trading in the exchange. The price may be transferred from the trader to the exchange, for example, by a broker, by online trading, on a special communication network, through a clearing house system, and/or using in any other desired system and/or method.

The price of an asset for immediate, e.g., 1 or 2 business days, delivery is called the spot price. For an asset sold in an option contract, the strike price is the agreed upon price at which the deal is executed if the option is exercised. For example, a stock option involves buying or selling a stock. The spot price is the current stock price on the exchange in which is the stock is traded. The strike price is the agreed upon price to buy/sell the stock if the option is exercised.

To facilitate trading of options and other financial instruments, a market maker suggests a bid price and offer price (also called ask price) for a certain option. The bid price is the price at which the market maker is willing to purchase the option and the offer price is the price at which the market maker is willing to sell the option. As a market practice, a first trader interested in a certain option may ask a second trader for a quote, e.g., without indicating whether the first trader is interested to buy or to sell the option. The second trader quotes both the bid and offer prices, not knowing whether the first trader is interested in selling or buying the option. The market maker may earn a margin by buying options at a first price and selling them at a second price, e.g., higher than the first price. The difference between the offer and bid prices is referred to as bid-offer spread.

A call option is the right to buy an asset at a certain price (“the strike”) at a certain time, e.g., on a certain date. A put option is the right to sell an asset at a strike price at a certain time, e.g., on a certain date. Every option has an expiration time in which the option ceases to exist. Prior to the option expiration time, the holder of the option may determine whether or not to exercise the option, depending on the prevailing spot price for the underlying asset. If the spot price at expiration is lower than the strike price, the holder will choose not to exercise the call option and lose only the cost of the option itself. However, if the strike is lower than the spot, the holder of the call option will exercise the right to buy the underlying asset at the strike price making a profit equal to the difference between the spot and the strike prices. The cost of the option is also referred to as the premium.

A forward rate is defined as the predetermined rate or price of an asset, at which an agreed upon future transaction will take place. The forward rate may be calculated based on a current rate of the asset, a current interest rate prevailing in the market, expected dividends (for stocks), cost of carry (for commodities), and/or other parameters depending on the underlying asset of the option.

An at-the-money forward option (ATM) is an option whose strike is equal to the forward rate of the asset. In some fields, the at-the-money forward options are generically referred to as at-the-money options, as is the common terminology in the commodities and interest rates options. The at the money equity options are actually the at the money spot, i.e. where the strike is the current spot rate or price.

An in-the-money call option is a call option whose strike is below the forward rate of the underlying asset, and an in the-money put option is a put option whose strike is above the forward rate of the underlying asset. An out-of-the-money call option is a call option whose strike is above the forward rate of the underlying asset, and an out-of-the-money put option is a put option whose strike is below the forward rate of the underlying asset.

An exotic option, in the context of this application, is a generic name referring to any type of option other than a standard Vanilla option. While certain types of exotic options have been extensively and frequently traded over the years, and are still traded today, other types of exotic options had been used in the past but are no longer in use today. Currently, the most common exotic options include “barrier” options, “digital” options, “binary” options, “partial barrier” options (also known as “window” options), “average” options, “compound” options and “quanto” options. Some exotic options can be described as a complex version of the standard (Vanilla) option. For example, barrier options are exotic options where the payoff depends on whether the underlying asset's price reaches a certain level, hereinafter referred to as “trigger”, during a certain period of time. The “pay off” of an option is defined as the cash realized by the holder of the option upon its expiration. There are generally two types of barrier options, namely, a knock-out option and a knock-in option. A knock-out option is an option that terminates if and when the spot reaches the trigger. A knock-in option comes into existence only when the underlying asset's price reaches the trigger. It is noted that the combined effect of a knock-out option with strike K and trigger B and a knock-in option with strike K and trigger B, both having the same expiration, is equivalent to a corresponding Vanilla option with strike K. Thus, knock-in options can be priced by pricing corresponding knock-out and vanilla options. Similarly, a one-touch option can be decomposed into two knock-in call options and two knock-in put options, a double no-touch option can be decomposed into two double knock-out options, and so on. It is appreciated that there are many other types of exotic options known in the art.

Certain types of options, e.g., Vanilla options, are commonly categorized as either European or American. A European option can be exercised only upon its expiration. An American option can be exercised at any time after purchase and before expiration. For example, an American Vanilla option has all the properties of the Vanilla option type described above, with the additional property that the owner can exercise the option at any time up to and including the option's expiration date. As is known in the art, the right to exercise an American option prior to expiration makes American options more expensive than corresponding European options.

Generally in this application, the term “Vanilla” refers to a European style Vanilla option. European Vanilla options are the most commonly traded options; they are typically traded over the counter (OTC). American Vanilla options are more popular in the exchanges and, in general, are more difficult to price.

### SUMMARY

Some demonstrative embodiments include devices, systems and methods of automatically defining financial derivative instruments.

In some demonstrative embodiments, a method may include receiving, by a computing device, an input sequence including a sequence of a plurality of input tokens; and based on the input sequence, defining, by the computing device, a financial derivative instrument by determining, based on the plurality of input tokens, values of a plurality of parameters configuring the financial derivative instrument.

In some demonstrative embodiments, defining the financial derivative instrument may include determining a type of the financial derivative instrument; identifying the plurality of parameters according to a predefined list of parameters corresponding to the type of the financial derivative instrument; and determining the values of the plurality of parameters by mapping the plurality of input tokens to the plurality of parameters.

In some demonstrative embodiments, determining the type of the financial derivative instrument may include determining the type of the financial derivative instrument based on a pattern of the plurality of tokens.

In some demonstrative embodiments, the mapping may include determining a plurality of different mapping combinations, each mapping combination including a different mapping of the plurality of tokens to the plurality of parameters. Defining the financial derivative instrument may include defining the financial derivative instrument according to one of the plurality of different mapping combinations.

In some demonstrative embodiments, the method may include ranking the plurality of different mapping combinations according to a predefined priority criterion corresponding to the type of the financial derivative instrument, the priority criterion defining priorities between the plurality of parameters; and selecting at least one of the different mapping combinations based on the ranking.

In some demonstrative embodiments, a number of the plurality of input tokens is lesser than a number of the plurality of parameters configuring the financial derivative instrument.

In some demonstrative embodiments, at least one parameter of the plurality of parameters does not correspond to any of the tokens.

In some demonstrative embodiments, determining the plurality of parameters may include determining the at least one parameter based on at least one respective parameter of a previously defined financial derivative instrument.

In some demonstrative embodiments, determining the plurality of parameters may include determining the at least one parameter based on at least one respective predefined parameter.

In some demonstrative embodiments, determining the plurality of parameters may include determining the plurality of parameters independent of an order of the tokens within the input sequence.

In some demonstrative embodiments, receiving the input sequence may include receiving a single text line including the plurality of input tokens.

In some demonstrative embodiments, receiving the input sequence may include receiving a voice message including the plurality of input tokens.

In some demonstrative embodiments, the method may include trading the financial derivative instrument.

In some demonstrative embodiments, the plurality of parameters may include one or more of a type parameter, a class parameter, a call parameter, a put parameter, a strike parameter, a trigger parameter, an expiration parameter, an amount parameter, a currency parameter, and a currency pair parameter.

In some demonstrative embodiments, a system may include a memory having stored thereon instructions; and a processor to execute the instructions resulting in an instrument definer application, wherein the instrument definer application is to receive an input sequence including a sequence of a plurality of input tokens; and based on the input sequence, to define a financial derivative instrument by determining, based on the plurality of input tokens, values of a plurality of parameters configuring the financial derivative instrument.

Some demonstrative embodiments include a machine-readable medium having stored thereon instructions, which when executed by a machine result in receiving an input sequence including a sequence of a plurality of input tokens; and based on the input sequence, defining a financial derivative instrument by determining, based on the plurality of input tokens, values of a plurality of parameters configuring the financial derivative instrument.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a system, in accordance with some demonstrative embodiments.

FIG. 2 is a screenshot illustration of interface components of a defined instrument, in accordance with some demonstrative embodiments.

FIG. 3 is a screenshot illustration of interface components of another defined instrument, in accordance with some demonstrative embodiments.

FIG. 4 is a screen shot illustration of interface components of a Risk-Reversal (RR) financial instrument defined with response to different input sequences, in accordance with some demonstrative embodiments.

FIG. 5 is a screen shot illustration of interface components of a Risk-Vanilla option financial instrument defined with response to different input sequences, in accordance with some demonstrative embodiments.

FIG. 6 is a screen shot illustration of interface components of a Risk-Call-spread financial instrument defined with response to different input sequences, in accordance with some demonstrative embodiments.

FIG. 7 is a screen shot illustration of interface components of a Risk-Reverse-Knockout financial instrument defined with response to different input sequences, in accordance with some demonstrative embodiments.

FIG. 8 is a screen shot illustration of interface components of a Risk-USD/Turkish Lira (TRY) Straddle financial instrument defined with response to different input sequences, in accordance with some demonstrative embodiments.

FIG. 9 is a screen shot illustration of interface components of a Risk-Australian Dollar (AUD/USD) Strangle financial instrument defined with response to different input sequences, in accordance with some demonstrative embodiments.

FIG. 10 is a schematic flow-chart illustration of a method of automatically defining a financial instrument, in accordance with some demonstrative embodiments.

FIG. 11 is schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a cellular telephone, a wireless telephone, a Personal Communication Systems (PCS) device, a PDA device which incorporates a wireless communication device, a device having one or more internal antennas and/or external antennas, a wired or wireless handheld device (e.g., BlackBerry, Palm Treo), a Wireless Application Protocol (WAP) device, or the like.

Some demonstrative embodiments are described herein in the context of automatically defining a financial instrument, e.g., a Foreign Exchange (FX) or Exchange-rate (ER) option, options on Interest Rate (IR) futures and/or options on commodities. It should be appreciated, however, that other embodiments may include automatically defining any other suitable financial instruments and/or markets, and the embodiments are not limited to stock options. One skilled in the art may apply the embodiments to other options and/or option-like financial instruments, e.g., any suitable options on any suitable asset instruments and/or options on non-asset instruments, such as options on the weather and/or the temperature, and the like, with variation as may be necessary to adapt for factors unique to a given financial instrument.

Some demonstrative embodiments are described herein in the context of automatically defining a financial instrument based on a user input in the form of input text. However, other embodiments may be implemented with respect to user input received in any other form. For example, some embodiments may be implemented to automatically define a financial instrument based on an audio user input, e.g., a voice input, for example, by utilizing any suitable voice-recognition method.

The phrase “financial derivative instrument” (also referred to as “financial instrument”, “trade structure”, “trade”, “deal” or “trade strategy”) may refer to any one or more suitable derivative instruments, e.g., forwards, swaps, futures, exchange options, OTC options, and the like, which derive their value from the value and characteristics of one or more underlying assets of any suitable “asset class”, e.g., FX, Interest Rate, Equity, Commodities, Credit, weather, energy, real estate, mortgages, and the like; and/or may involve more than one asset class, e.g., cross-asset, multi asset, and the like. The phrase “financial instrument” may also refer to any suitable combination or structure of one or more financial instruments.

The phrase “defining a financial instrument” may refer to setting, determining, establishing and/or defining a plurality of parameters (“financial instrument parameters”), which configure, construct, create, build and/or define a financial instrument, for example, in a manner, which may enable trading, pricing, handling, and/or processing the financial instrument.

A user may be required to define a financial instrument, for example, in order to price the financial instrument, analyze the financial instrument, trade the financial instrument, convey the financial instrument to another user and/or entity, process the financial instrument and/or handle the financial instrument in any other suitable manner. For example, when traders want to perform a trade they must convey to their counterparty the type of trade they want to perform. Given the trade type there is a list of field names and values that needs to be specified. In one example, for a deal of type “vanilla call option” a user may have to specify the following parameters:

Deal type=Vanilla

Call=USD

Put=JPY

Strike=85

Expiry=3 Months

Notional=1 Million

It is noted that deals of higher complexity may have additional parameters.

Explicitly specifying the entire list of keywords and values is cumbersome and not strictly necessary as much of the values may be inferred from a much more condensed representation, such as the representation: “p JPY 85 3m 1M”

People who trade financial instruments have developed a language for describing deals in a concise economic manner. This language allows traders to communicate efficiently either orally or when using text based messaging services quickly and efficiency. This language has the following challenging traits:
Language tokens may be shortened, even to a single character (for example Vanilla may be referenced as ‘van’ or simply ‘v’);
The order in which tokens are arranged is to a large extent arbitrary;
Tokens may be “glued” together into one larger token (e.g., the tokens USD and JPY may appear as USDJPY); and/or
Some tokens may be altogether excluded, e.g., when the missing tokens can be logically inferred from other tokens; and/or when the missing tokens have an agreed upon default that should be used if missing.

Any human involved in trading financial instruments can “speak” this language after some training Some embodiments may be enabled to automatically convert and/or parse sentences given in this language, identify the tokens, and generate a full description of the deal in a format that can be then passed on to any type of system that may require deal entry as part of the workflows it supports.

Some demonstrative embodiments may include automatically defining a financial instrument based on information, e.g., partial information, received, e.g., from a user. In one example, the user may provide an input, e.g., a single line or single syntax input, including input information for defining a financial instrument.

The input information may include, for example, partial information, e.g., information relating to only some of the financial instrument parameters (“the user-defined parameters”) required for defining the financial instrument. For example, a user may enter the input information including only some of an option class, a strike, a currency pair, a notional amount, and an expiration date of a FX instrument. In one example, the user may enter the input information including only the option class, the strike, the currency pair and the expiration date of the FX instrument, while omitting the notional amount of the FX instrument.

Additionally or alternatively, the user input may include the user-defined parameters in any suitable order and/or form.

In some demonstrative embodiments, the input information may include an input sequence (also referred to as “input sentence”, “input syntax”, “input string” or “input stream”), e.g., a single input sequence, including a sequence of a plurality of tokens, e.g., user-defined tokens.

In one example, the input sequence may include a text sequence, e.g., a single text line. In another example, the input sequence may include a voice sequence, e.g., a single voice message.

For example, the user may enter the input information including any suitable tokens representing the user-defined parameters. The “tokens” may include any suitable codes, symbols, code words, abbreviations, and the like. In one example, the user may enter an input sequence including the token “v”, the token “va”, the token “van”, the token “V”, the token “Van”, the token “VAN”, the token “VANILLA” and/or any other suitable token representing a parameter defining a type of the financial instrument to include a Vanilla option. In another example, the user may enter an input sequence including the token “1m”, the token “m”, the token “1mil”, the token “1mio”, the token “1M”, the token “MIO”, the token “One” and/or any other suitable token representing a parameter defining a notional amount of the financial instrument to be one million Dollars.

Additionally or alternatively, the user may enter the input information including the tokens in any suitable order, e.g., a random order, an arbitrary order, a user-defined order or any other desired order. In one example, the user may enter the input information including the tokens in the order of financial instrument type, notional amount, and strike price. In another example, the user may enter the input information including the financial instrument tokens in the order of notional amount, financial instrument type, and strike price.

In some embodiments, the financial instrument may be automatically defined based on the input information. For example, the user may enter an input sequence “sell 25d call buy 25d put” and, based on the input sequence, an instrument definer module may automatically define a financial instrument including a Risk Reversal Euro (EUR)/US Dollar (USD) structure, including selling a 25 delta vanilla call option and buying a 25 d vanilla put both with an expiration date of three months from a current trade date, and at a notional amount of ten million EURO, e.g., which may be determined based on a predefined default notional amount.

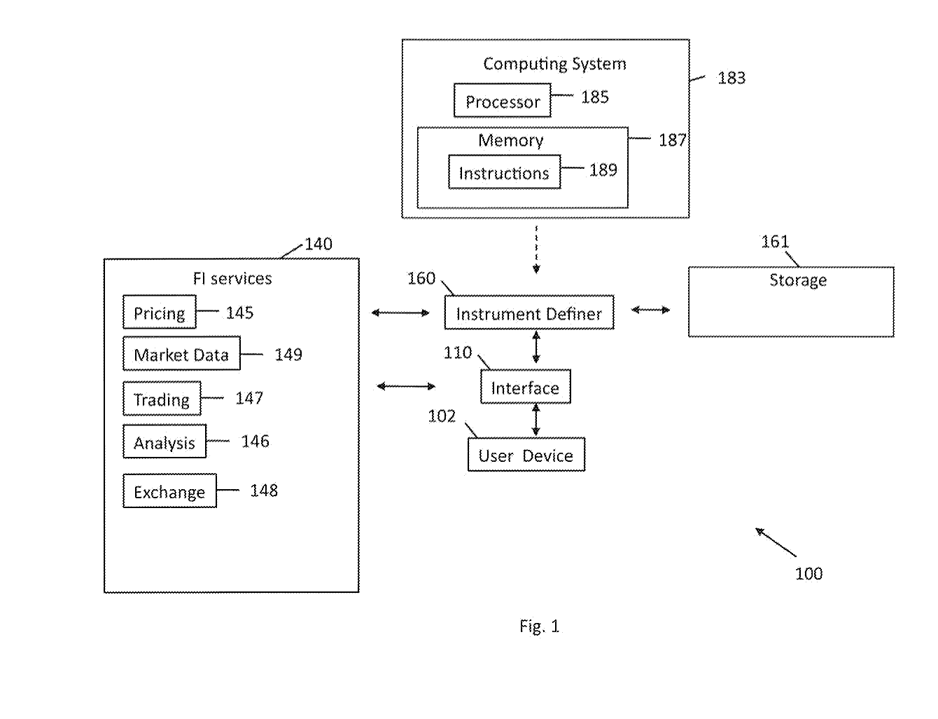

Reference is now made to FIG. 1, which schematically illustrates a block diagram of a system 100, in accordance with some demonstrative embodiments.

In some demonstrative embodiments, system 100 may include a financial instrument definer module 160 to automatically define one or more financial instruments based on an input, which may be received, for example, received from a user or from any other source, e.g., as described below.

In some demonstrative embodiments, module 160 may be capable of automatically defining any suitable financial instrument on any suitable underlying asset, e.g. currencies, interest rates, commodities, equity, energy, credit, weather, and the like.

In some demonstrative embodiments, system 100 includes one or more user stations or devices 102, for example, a PC, a laptop computer, a PDA device, and/or a terminal, to allow one or more users to define the one or more financial instruments using module 160, e.g., as described herein.

In some demonstrative embodiments, devices 102 may be implemented using suitable hardware components and/or software components, for example, processors, controllers, memory units, storage units, input units, output units, communication units, operating systems, applications, or the like.

The user of device 102 may include, for example, a trader, a business analyst, a corporate structuring manager, a salesperson, a risk manager, a front office manager, a back office, a middle office, a system administrator, and the like.

In some demonstrative embodiments, system 100 may also include an interface 110 to interface between users 102 and one or more elements of system 100, e.g., module 160. Interface 110 may optionally interface between users 102 and one or more Financial-Instrument (FI) systems and/or services 140. Services 140 may include, for example, a suitable pricing module 145 capable of pricing one or more financial instruments according to any suitable pricing method and/or algorithm, one or more market data services 149, one or more trading systems 147, one or more exchange connectivity systems 148, one or more analysis services 146 and/or one or more other suitable FI-related services, systems and/or platforms.

In some demonstrative embodiments, module 160 may be capable of communicating, directly or indirectly, e.g., via interface 110 and/or any other interface, with one or more suitable modules of system 100, for example, one or more of FI systems 140, a database, a storage, an archive, an HTTP service, an FTP service, an application, and/or any suitable module capable of providing, e.g., automatically, input to module 160 and/or receiving output generated by module 160, e.g., as described herein.

In some demonstrative embodiments, module 160 may be implemented as part of FI systems/services 140, e.g., as part of, or in association with, pricing module 145, as part of device 102 and/or as part of any other suitable system or module, e.g., as part of any suitable server, or as a dedicated server.

In some demonstrative embodiments, module 160 may include a local or remote application executed by any suitable computing system 183. For example, computing system 183 may include a suitable memory 187 having stored-thereon application instructions 189, and a suitable processor 185 to execute instructions 189 resulting in module 160.

In some demonstrative embodiments, computing system 183 may include or may be part of a server to provide the functionality of module 160 to users 102. In other embodiments, computing system 183 may be implemented as part of user station 102. For example, instructions 189 may be downloaded and/or received by users 102 from another computing system, such that module 160 may be locally executed by users 102. For example, instructions 189 may be received and stored, e.g., temporarily, in a memory or any suitable short-term memory or buffer of user device 102, e.g., prior to being executed by a processor of user device 102. In other embodiments, computing system 183 may include any other suitable computing arrangement, server and/or scheme.

In some demonstrative embodiments, computing system 183 may also execute one or more of FI systems/services 140. In other embodiments, module 160 may be implemented separately from one or more of FI systems/services 140.

In some demonstrative embodiments, interface 110 may be implemented as part of module 160, FI systems/services 140 and/or as part of any other suitable system or module, e.g., as part of any suitable server.

In some demonstrative embodiments, interface 110 may be associated with and/or included as part of devices 102. In one example, interface 110 may be implemented, for example, as middleware, as part of any suitable application, and/or as part of a server. Interface 110 may be implemented using any suitable hardware components and/or software components, for example, processors, controllers, memory units, storage units, input units, output units, communication units, operating systems, applications. In some demonstrative embodiments, interface 110 may include, or may be part of a Web-based pricing application interface, a web-site, a web-page, a stand-alone application, a plug-in, an ActiveX control, a rich content component (e.g., a Flash or Shockwave component), or the like.

In some demonstrative embodiments, interface 110 may also interface between users 102 and one or more of FI systems and/or services 140.

In some demonstrative embodiments, interface 110 may be configured to allow users 102 to enter commands; to enter an input sequence, e.g., a single line or single syntax input, including input information for defining a financial instrument; to define and/or structure a trade corresponding to the financial instrument; to transact the trade; and/or to perform any other suitable operation. For example, interface 110 may include or may be associated with a suitable Graphical User Interface (GUI).

In some demonstrative embodiments, interface 110 and module 160 may be implemented as part of an application server to process user information, which may be received from user 102, as well as trade information, which may be received, for example, from market data service 149. System 100 may also include storage 161, e.g., a database, for storing the user information and/or the trade information.

The user information may be received from user 102, for example, via a communication network, for example, the Internet, e.g., using a direct telephone connection or a Secure Socket Layer (SSL) connection, a Local Area Network (LAN), or via any other communication network known in the art. Module 160 may communicate to user 102 financial instrument parameters defining a financial instrument based on the user input via interface 110, e.g., in a format convenient for presentation to user 102.

In some demonstrative embodiments, module 160 may receive input information, e.g., partial information, from user 102. In one example, user 102 may provide the user input in the form of a single line or single syntax input, including input information for defining a financial instrument.

In some embodiments, module 160 may receive a text input sequence, e.g., a single text line including a sequence of a plurality of input tokens.

In some embodiments, module 160 may receive a voice message, e.g., in the form of any suitable audio file, e.g., an mp3 file, a way file, and the like. Module 160 may include any suitable speech recognition module and/or algorithm to determine and/or identify the plurality of input tokens included in the voice message. For example, interface 110 may include any suitable audio interface capable of receiving from user 102 an audio input including a voice message from user 102. Module may identify a plurality of tokens by applying any suitable speech recognition algorithm to the voice message. Module 160 may then automatically define the financial derivative instrument based on the identified tokens, e.g., as described in detail below.

The input information may include, for example, partial information, e.g., information relating to only some of the financial instrument parameters (also referred to as “the user-defined parameters” or “user-defined tokens”) required for defining the financial instrument. For example, user 102 may enter the input information including only some of an option class, a strike, a currency pair, a notional amount, and an expiration date of a FX instrument. In one example, user 102 may enter the input information including only the option class, the strike, the currency pair and the expiration date of the FX instrument, while omitting the notional amount of the FX instrument.

Additionally or alternatively, the user input may include the tokens in any suitable order and/or form.

For example, user 102 may enter the input information including any suitable tokens representing the user-defined parameters. In one example, user 102 may enter an input sequence including the token “v”, the token “va”, the token “van”, the token “V”, the token “Van”, the token “VAN”, the token “VANILLA” and/or any other suitable token representing a parameter defining a type of the financial instrument to include a Vanilla option. In another example, user 102 may enter an input sequence including the token “1m”, the token “m”, the token “1mil”, the token “1mio”, the token “1M”, the token “MIO”, the token “One” and/or any other suitable token representing a parameter defining a notional amount of the financial instrument to be one million Dollars.

Additionally or alternatively, user 102 may enter the input information including the user-defined tokens in any suitable order, e.g., a random order, an arbitrary order, a user-defined order or any other desired order. In one example, user 102 may enter the input information including the financial instrument tokens in the order of financial instrument type, notional amount, and strike price. In another example, user 102 may enter the input information including the financial instrument tokens in the order of notional amount, financial instrument type, and strike price.

In some embodiments, module 102 may automatically define the financial instrument based on the user input information. For example, user 102 may enter an input sequence “3m EUR/USD ATM Std” and, based on the input sequence, module 160 may automatically define a financial instrument including a Straddle Euro (EUR)/US Dollar (USD) having an At-The-Money (ATM) strike, an expiration date of three months from a current trade date, and at a notional amount of ten million EURO, e.g., which may be determined based on a predefined default notional amount.

In some demonstrative embodiments, module 160 may define the financial instrument taking into account one or more previous financial instruments, which were previously defined, priced, traded and/or otherwise handled and/or processed by user 102. For example, if the previous financial instruments all relate to a certain notional amount, e.g., one hundred million USD, then module 160 may automatically define a financial instrument to have the certain notional amount, e.g., even if user 102 does not provide a notional amount in the input sequence. If, for example, the previous financial instruments all include FX instruments relating to a certain currency pair, e.g., the currency pair EUR/USD, then module 160 may automatically define a FX financial instrument to relate to the certain currency pair, e.g., even if user 102 does not provide a currency pair, or even a type of the financial instrument, in the input sequence.

In some demonstrative embodiments, module 160 may prompt to user 102 to select from one or more optional financial instruments, e.g., based on the previous financial instruments.

In some demonstrative embodiments, the financial instrument may be defined by defining a combination of a currency pair parameter, an option class parameter, an instrument type parameter, a strike parameter, an expiration date parameter, a trigger and/or barrier parameter, and/or any other suitable parameter.

In some demonstrative embodiments, module 160 may receive from user the input sequence tokens defining one or more of the financial instrument parameters, e.g., in any suitable form and/or order. Module 106 may be configured to define the financial instrument based on the received input sequence.

In some demonstrative embodiments, module 160 and/or interface 110 may provide user 102 with at least one potential financial instrument corresponding to the input sequence, and to prompt user 102 to select one of the potential financial instruments or to deny all of the potential financial instruments.

In some demonstrative embodiments, module 160 may utilize one or more predefined default financial instrument parameter values, for example, if the input sequence does not include information relating to the default parameters. The default parameters may be predefined by user 102 and/or by an administrator. Additionally or alternatively, one or more of the default parameters may be defined based on the previous financial instruments defined handled by user 102, e.g., as described above.

In some demonstrative embodiments, module 160 may utilize at least one of a default option class, e.g., based on a definition by user 102 and/or based on previous financial instruments handled by user 102; a default currency pair, e.g., based on a definition by user 102 and/or based on previous financial instruments handled by user 102; a default nominal amount, for example, ten million of a base currency and/or any other value based on a definition by user 102 and/or based on previous financial instruments handled by user 102; a default expiration date, for example, three months from a current trade date and/or any other value based on a definition by user 102 and/or based on previous financial instruments handled by user 102; and a default instrument type, for example, a “call” and/or any other value based on a definition by user 102 and/or based on previous financial instruments handled by user 102.

In some demonstrative embodiments, module 160 may be configured to support parsing, such that, for example, if the input sequence includes a value, e.g., a strike price and/or a trigger, without a decimal point, then module 160 may convert the value to a suitable value including the decimal point.

In some demonstrative embodiments, module 160 may support input sequences including upper case and/or lowercase tokens.

In One demonstrative embodiments, module 160 may automatically identify the tokens “Vanilla”, “Van” and/or “Va” as referring to a Vanilla option class; module 160 may automatically identify the tokens “Knock Out”, “KnockOut”, “KO”, KNO″ and/or “ko” as referring to a knockout option class; module 160 may automatically identify the tokens “Reverse Knock out”, “RKO” and/or “ReverseKnockOut” as referring to a Reverse Knockout class; module 160 may automatically identify the tokens “Straddle”, “STD” and/or “STRAD” as referring to a Straddle class; module 160 may automatically identify the tokens “Strangle”, “STG” and/or “STRAN” as referring to a Strangle class. Module 106 may automatically identify the tokens “one”, “1” and/or “ONE” as referring to a an amount of one; module 160 may automatically identify the tokens “Mi”, “Mil”, “Mio” and/or “Million” as referring to an amount of one million. Module 106 may automatically identify the following token formats with respect to a price, e.g., a strike price: 1.45, 145, 20 Delta, 20D, D20, 2O, O2, 2I, I2, F, ATM, A. module 160 may automatically identify the tokens “C”, “Ca”, “Cal” and/or “Call” as referring to a “call”. Module 106 may automatically identify the tokens “P”, “Pu” and/or “Put” as referring to a “Put”. Module 106 may automatically identify the tokens “EURO”, “EUR” and/or “Eu” as referring to the currency EUR. Module 106 may automatically identify the tokens “EUR/USD” and/or “EURUSD” as referring to the currency pair EUR/USD.

In some demonstrative embodiments, if the input sequence includes only one currency, then module 160 may assume that the second currency includes a predefined currency, for example, USD and/or any other currency based on a definition by user 102 and/or based on previous financial instruments handled by user 102.

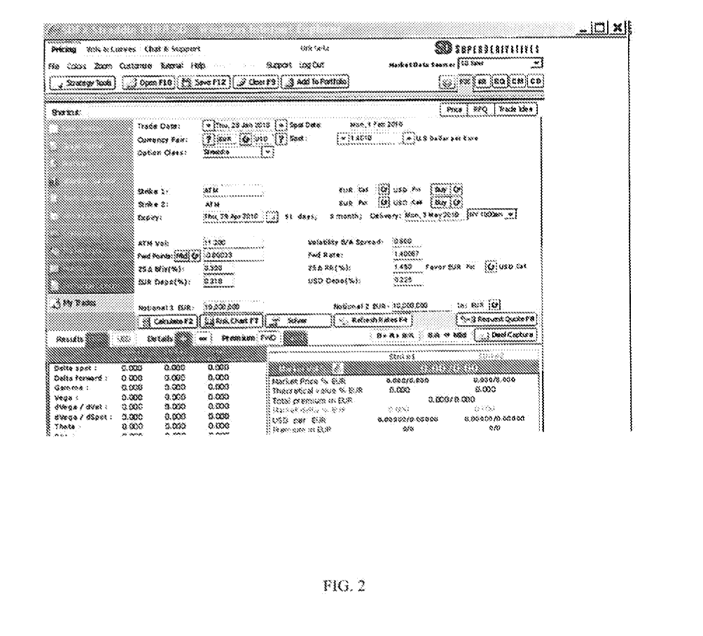

In one example, module 160 may receive from user 102 the input sequence: “3m EUR/USD ATM Std”. Based on the input sequence, module 160 may automatically define a financial instrument. For example, module 160 may automatically define the notional amount of the financial instrument to be ten million EURO, for example, according to a default notional amount, which may be defined by user 102 and/or determined by module 106 based on previous financial instruments handled by user 102. Module 106 may define the financial instrument to include a Straddle EUR/USD having an ATM strike, an expiration date of three months from a current trade date, and a notional amount of ten million EURO. FIG. 2 includes a screenshot illustration of interface components of the defined instrument.

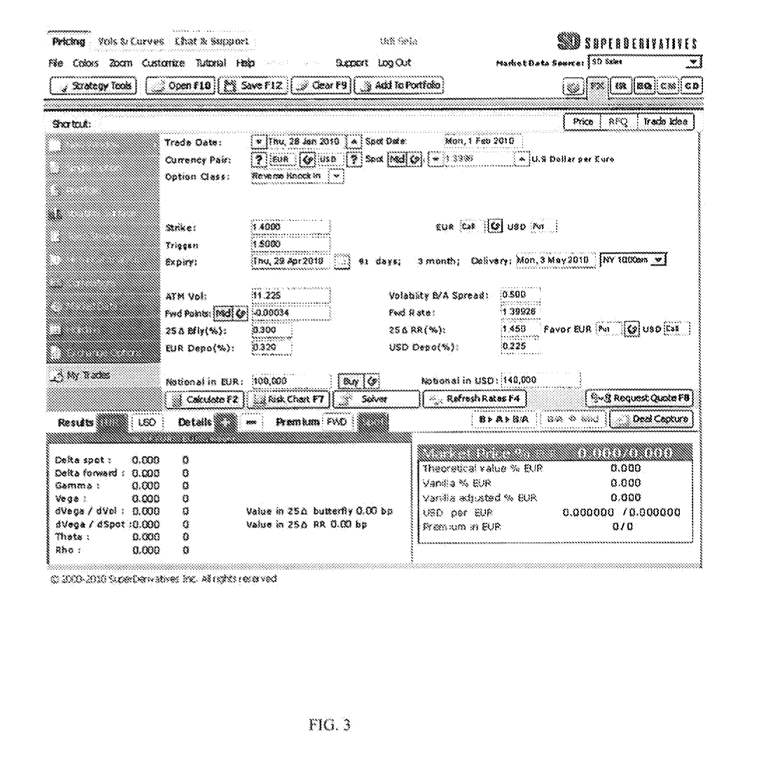

In another example, module 160 may receive from user 102 the sequence: “RKI 1.4 1.5 Euro 10 k”. Based on the input sequence, module 160 may automatically define a financial instrument. For example, module 160 may automatically define the expiration date of the financial instrument to be three months from a current trade date, for example, according to a default expiration date, which may be defined by user 102 and/or determined by module 160 based on previous financial instruments handled by user 102; module 160 may automatically define the instrument type of the financial instrument to be a “call”, for example, according to a default instrument type, which may be defined by user 102 and/or determined by module 160 based on previous financial instruments handled by user 102; and/or module 160 may automatically define the currency pair of the financial instrument to be EUR/USD, for example, according to a default currency pair, which may be defined by user 102 and/or determined by module 160 based on previous financial instruments handled by user 102. Module 106 may define the financial instrument to include a EUR/USD Call Reverse Knock In having a strike of 1.4, a trigger of 1.5, an expiration date of three months from a current trade date, and a notional amount of 100,000 EURO. Module 106 may determine that the token “1.4” relates to the strike price and that the token “1.5” relates to the trigger, for example, regardless of the order of appearance within the input sequence. Module 106 may make such a decision based, for example, to a logical constraint relating to the financial instrument, e.g., since the strike price must be lower than the trigger price. FIG. 3 includes a screen shot illustration of interface components of the defined instrument.

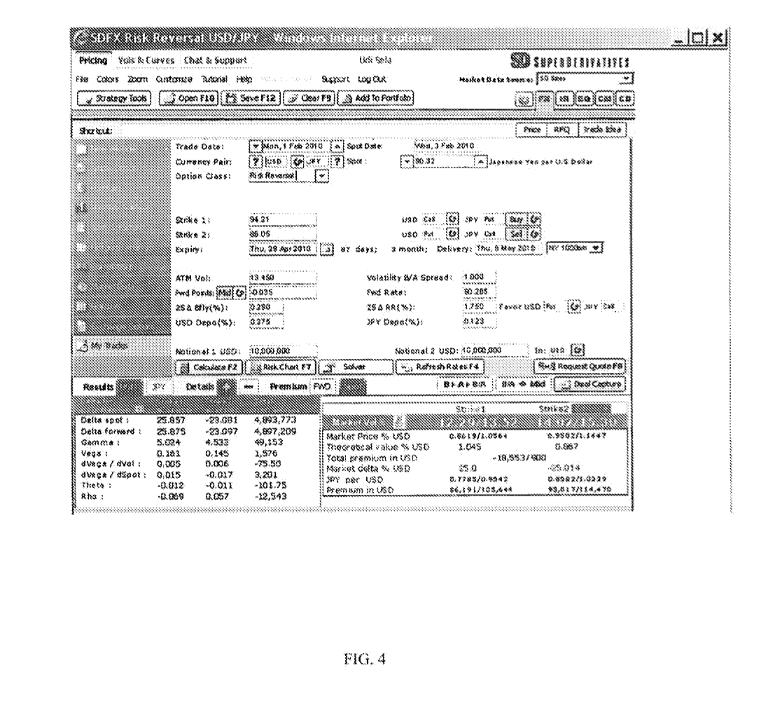

FIG. 4 includes a screen shot illustration of interface components of a Risk-Reversal (RR) financial instrument, which may be defined by module 160, for example, with response to each of the following different input sequences:

3m yen 25drr 10mio

USD/JPY 25D 3M in 10

J 3M D25 RR

3M USDJPY 10 MIO RR25D

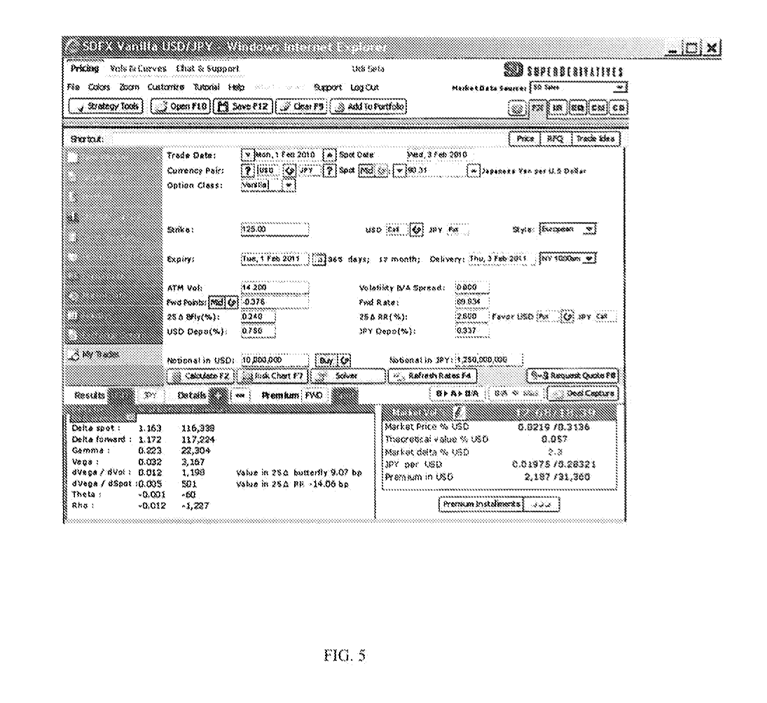

FIG. 5 includes a screen shot illustration of interface components of a Vanilla option financial instrument, which may be defined by module 160, for example, with response to each of the following different input sequences:

125 usd c jpy p 10m 1y

One year Call 125 USD/JPY 10,000,000

PUT JPY 125 10 MIO 1y

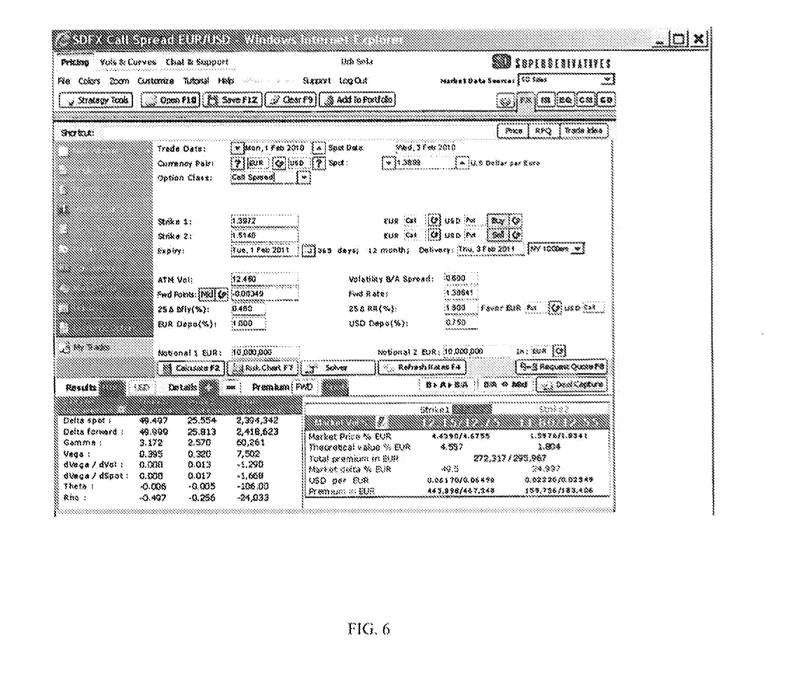

FIG. 6 includes a screen shot illustration of interface components of a Call-spread financial instrument, which may be defined by module 160, for example, with response to each of the following different input sequences:

Atm vs 25d euro call spread 1y 10m leg

Eur/usd Call spread 25d/atm 1Y 10 a/l

Euro call spread 1y 10 per atm/25d

Spread Call Euro 25d vs atm in 10 1 year

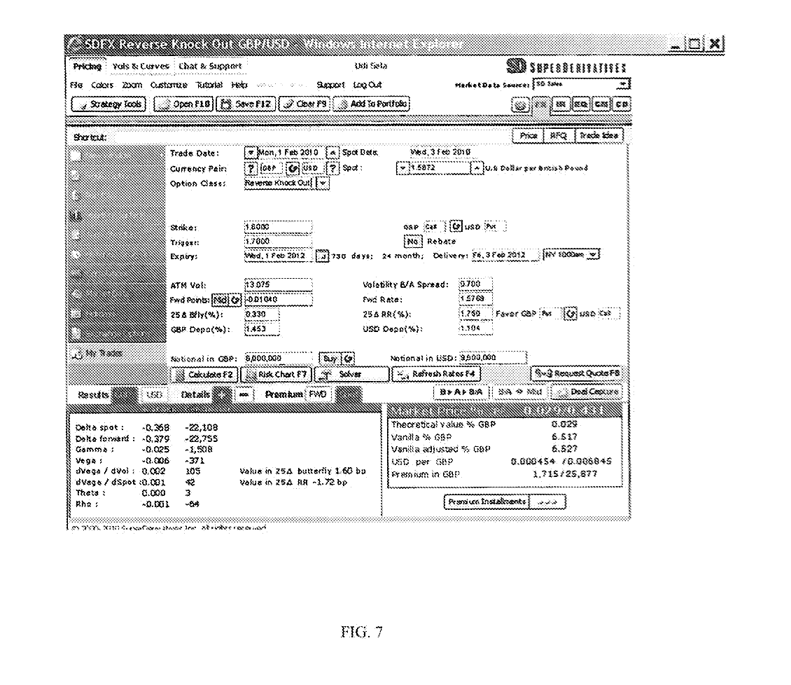

FIG. 7 includes a screen shot illustration of interface components of a Reverse-Knockout financial instrument, which may be defined by module 160, for example, with response to each of the following different input sequences:

160 gbp c usd p rko 170 6mio 2y

2 years Call GBP/USD 160/170 in 6

Put USD Call GBP reverse ko two years sp 160 ko 170 6mm

Rko 170 call GBP 2y strike 160 6 million

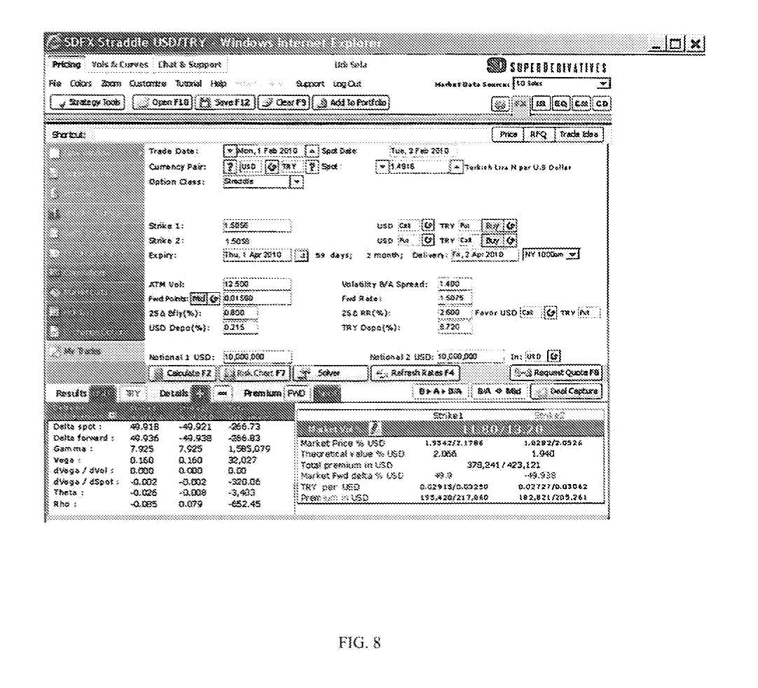

FIG. 8 includes a screen shot illustration of interface components of a USD/Turkish Lira (TRY) Straddle financial instrument, which may be defined by module 160, for example, with response to each of the following different input sequences:

Try 2m atm straddle 10 a/l

Atm std usd/try two m in 10

Usd/try a stra 2m 10 per

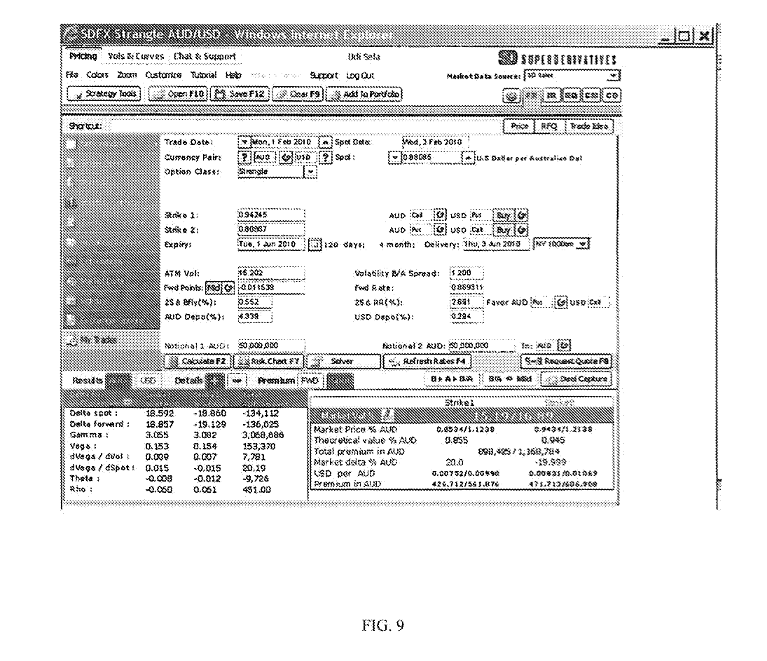

FIG. 9 includes a screen shot illustration of interface components of a Australian Dollar (AUD/USD) Strangle financial instrument, which may be defined by module 160, for example, with response to each of the following different input sequences: 4M AUD 20D Strangle in 50

Aud/usd stg four mon d20 50 al

Strangle AUD 4M 20 Delta 50 per

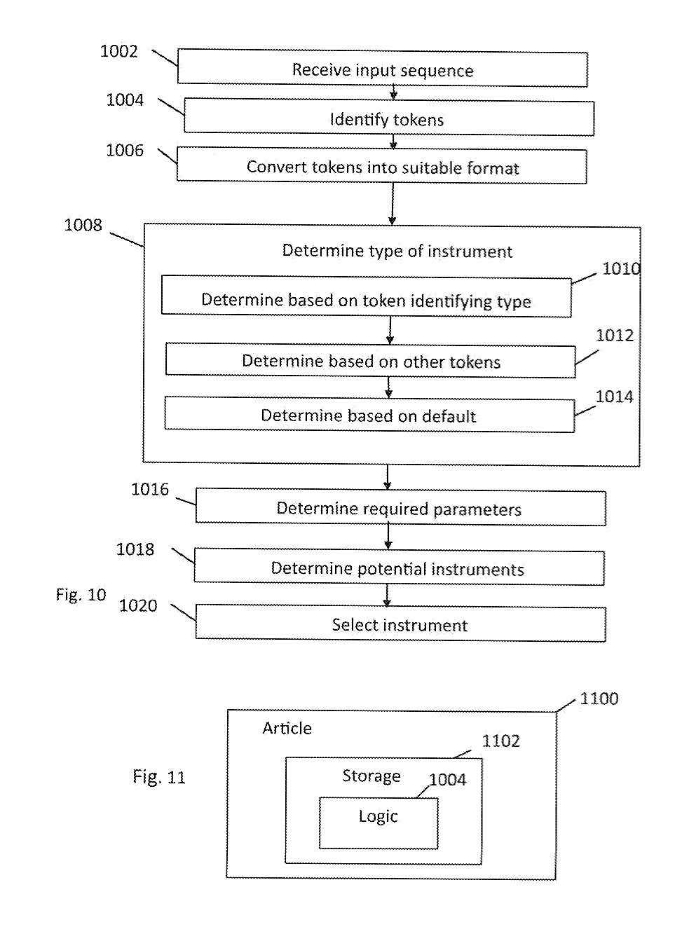

Reference is made to FIG. 10, which schematically illustrates a method of automatically defining a financial instrument, in accordance with some demonstrative embodiments. In some embodiments, one or more operations of the method of FIG. 10 may be performed by one or more elements of a system, e.g., system, 100 (FIG. 1), for example, a financial instrument definition module, e.g., module 160 (FIG. 1), to automatically define a financial instrument based on user input received from a user.

As indicated at block 1002, the method may include receiving user input corresponding to a financial instrument to be defined. For example, the user input may include an input sequence received from user 102 (FIG. 1). The input sequence may include, for example, a text input or a voice input including a sequence of a plurality of tokens, e.g., as defined above.

As indicated at block 1004, the method may include splitting the user input into a plurality of tokens. For example, module 160 (FIG. 1) may break the input sequence from user 102 (FIG. 1) into a plurality of tokens, e.g., each including a portion of the input sequence separated by delimiters, e.g., a space, a comma and the like.

As indicated at block 1006, the method may include converting one or more tokens into a suitable format, for example, converting a number entered in alphabetic form, e.g., “five”, into a numeric form, e.g., 5.

As indicated at block 1008, the method may include determining the type of the financial instrument to be defined.

As indicated at block 1010, determining the type of the financial instrument may include determining the type of the financial instrument according to a token of the plurality of tokens, for example, if the input sequence includes a token identifying the type of the financial instrument.

As indicated at block 1012, determining the type of the financial instrument may include determining the type of the financial instrument based on one or more other tokens of the input sequence, for example, if the input sequence does not include a token identifying the type of the financial instrument. For example, if the input sequence includes the sequence “buy atm call sell 25d put”, then module 160 (FIG. 1) may determine the type of the financial instrument to include a risk reversal instrument.

As indicated at block 1014, determining the type of the financial instrument may include determining the type of the financial instrument based on a default setting, for example, if the type of the financial instrument cannot be determined based on one or more other tokens of the input sequence.

As indicated at block 1016, the method may include determining a plurality of required parameters for defining the financial instrument, e.g., based on the determined type of the financial instrument. For example, a vanilla instrument may require a definition of the underlying asset, strike price, expiration date, call/put, buy/sell, a notional amount, and a notionalSide. For example, module 160 (FIG. 1) may include a predefined list of the required parameters, e.g., stored by storage 161 (FIG. 1), corresponding to one or more predefined types of financial instruments.

As indicated at block 1018, the method may include determining one or more potential financial instruments based on the input sequence.

As indicated at block 1020, the method may include selecting a financial instrument from the potential financial instruments. For example, the method may include ranking the potential financial instruments according to any suitable ranking criterion, and selecting the financial instrument having a highest rank.

Referring back to FIG. 1, in some demonstrative embodiments, module 160 may parse an input sequence (“sentence”) into tokens according to characters used as separators; identify the deal at hand, for example, by finding a token that maps into a deal name, by inferring the deal from known patterns, or by using the default deal type if other identification schemes failed.

In some demonstrative embodiments, module 160 may load a list of parameter-patterns (regular expressions) for each type of token that is part of the deal descriptions. Module 106 may attempt to map tokens to patterns resulting with a list of possible mappings. Each mapping may define how each token maps, if at all, to some field in the description of the deal.

In some demonstrative embodiments, module 160 may validate each potential mapping against logic specific to the identified deal. For example, for a Double Knock out Option the current spot must fall between the two triggers—any mapping of tokens where the two trigger values are both below or both above the spot is not logical, and thus may be discarded.

In some demonstrative embodiments, module 160 may give a score to each possible mapping of tokens to deal configuration items according to predefined rules. Module 106 may determine all possible resulting mappings using the result set ranked by score. Module 106 may choose the highest scoring mapping for user 102, or allow user 102 to choose from within the top resulting rankings

In some demonstrative embodiments, module 160 may implement a feedback loop. For example, if user 102 is presented with several options module 160 may record the choice of user 102. If the user changes the resulting deal, module 160 may record the change. The mappings preferred by the user are then given higher priority, e.g., if they are repeated in the future by the same user.

In some demonstrative embodiments, module 160 may perform an algorithm calibration task, e.g., at a setup stage. For example, Module 106 may recognize that each instrument has a set of deal configuration items. A deal configuration item may represent an input token for a given instrument (strike expiry and notional are examples items required to define a vanilla option). A deal configuration item may have a priority within a defined instrument according to how likely it is to be explicitly stated by the user, as opposed to how likely it is to be eliminated by the user as the parameter has suitable default.

The following table provides an example of a list of deals and the priorities assigned to the deal items relevant to those deals:

TABLE 1

| | dealConfigurationItem | | | | |
|---|---|---|---|---|---|
| Instrument | Strike1 | Strike2 | Trigger | Expiry | Notional |
| van | 1 | — | — | 2 | 3 |
| RiskReversal | 1 | 2 | | 3 | 4 |
| Knockout | 1 | — | 2 | 3 | 4 |

For example, as shown in Table 1, for a Knock Out deal it is most important to identify the strike, then the trigger, then the expiry, and last the notional.

In some demonstrative embodiments, module 160 may pre-process the input sequence, for example, by converting and replacing special phrases and signs (for example, replace numbers represented by words into numerals as in converting five into 5); and/or breaking the input sequence into tokens separated by pre defined delimiters.

In some demonstrative embodiments, module 160 may attempt to identify the target instrument by attempting to identify an explicit recognized instrument name or shortcut (for example: “vanilla”, “van”, “v”). If no explicit name was found, module 160 may attempt to find a pattern, from which a specific instrument type may be implied (for example “buy <strike token> call sell <strike token>put” can be identified as a “risk reversal” deal). If both of the steps above failed, then, for example, module 160 may use a default instrument type that may be configured by user 102 (for example vanilla in Foreign Exchange deals).

In some demonstrative embodiments, once the deal is identified, module 160 may list the deal items that are required to describe the deal. There may be a list, per item, of patterns that may be used to identify it, e.g., stored by storage 161. Module 106 may select the patterns and assign each pattern a numerical score denoting the probability that the pattern will actually be used to identify a certain deal item.

The following table provides a few examples of patterns, their description, and their associated priority:

TABLE 2

| DealConfigurationItem | Regular expression | Priority | Description |
|---|---|---|---|
| Strike1 | Atm | 1 | Strike = at the |
| | | | money |
| Strike1 | (atm\|at\|a)\s?(forward) | 2 | Strike = at the |
| | | | money forward |
| Strike1 | (atm\|at\|a)\s?(spot) | 3 | Strike = at the |
| | | | money spot |
| Expiry | \d+\s?months | 1 | Expiry = |
| | | | <number> |
| | | | months; |
| Expiry | \d+\s?weeks | 2 | Expiry = |
| | | | <number> |
| | | | weeks; |

In some demonstrative embodiments, module 160 may attempt to match each deal item pattern with the input text. For example, module 160 may loop over all deal configuration items associated with the deal. For each item, module 160 may loop over all possible patterns. For each pattern, module 160 may attempt to match with input text. If a match is found, module 160 may associate the deal configuration item with the token, and keep it in a list.

In some demonstrative embodiments, module 160 may attempt to build all possible combinations of assigning tokens to deal configuration items based on the result of the pattern matching stage. One way of performing this task is in a recursive manner. For example, module 160 may begin with a certain deal configuration item and let it choose it possible token, one after another. For each token choice, module 160 may remove the token, and let the remaining items choose their own tokens from the remaining tokens. Module 106 allow each token the opportunity to choose first in order to make sure that all possible combinations are found. Module 106 may then collect all resulting mappings and remove any duplication created in the process.

In some demonstrative embodiments, module 160 may have a set of combinations that are syntactically legal—but not all may be logical. Module 106 may observe each resulting combination—that is each possible deal description, and validate it against a set of business rules. For example, if a set of two triggers is identified for a double knock out instrument, their values must be located at either side of underlying observed rate (for example, one trigger must be higher than spot, and the other lower). Combinations that fail to validate are eliminated.

In some demonstrative embodiments, module 160 may apply a heuristic algorithm to rank to remaining valid combinations. For example, module 160 may take into account at least part of the following information:
The priorities of the deal items actually identified for each combination. For example, in Table 1 —a combination that matches strike and expiry is preferable to a combination matching expiry and notional;
The priority assigned to mapping any given token to a certain item. For example, the priority of identifying 25d as an expiry of 25 days is higher than the priority for identifying 25d as a strike;
The probability of matching a given item to a given value. For example, for a USD JPY option, the probability of matching the value 1000000 to a notional and 85 to a strike is higher than the probability of matching 1000000 to the strike, and 85 to the notional.

In some demonstrative embodiments, module 160 may display the best result or allow the user to choose from a few possibilities.

In some demonstrative embodiments, if the user may choose, or otherwise alter the resulting patterns, the altered pattern may be passed back to the module 160, which may store this preference so that it is ranked higher if ever encountered again.

Reference is made to FIG. 11, which schematically illustrates an article of manufacture 1100, in accordance with some demonstrative embodiments. Article 1100 may include a machine-readable storage medium 1102 to store logic 1104, which may be used, for example, to perform at least part of the functionality of module 160 (FIG. 1) and/or interface 111 (FIG. 1); and/or to perform one or more operations described herein.

In some demonstrative embodiments, article 1100 and/or machine-readable storage medium 1102 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 1104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 1104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, some embodiments are not described with reference to any particular programming language. It will be appreciated that a variety of programming languages may be used to implement the teachings of the invention as described herein.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. (canceled)

2. A system comprising:
a storage configured to store parameter information corresponding to a plurality of predefined financial derivative instrument types, the parameter information comprising, for a predefined financial derivative instrument type, a plurality of financial instrument parameters to define the predefined financial derivative instrument type, and, for a parameter of the plurality of financial instrument parameters, a plurality of potential input patterns to define the parameter;
an interface to receive an input sequence comprising a sequence of a plurality of input tokens; and
a processor configured to process said input sequence and to determine, based on said plurality of input tokens, an identified type of a financial derivative instrument to be defined by the input sequence, said processor is configured to access said storage, based on the identified type, and to retrieve a plurality of retrieved financial instrument parameters corresponding to the identified type, said processor is configured to determine a plurality of different mapping combinations, a mapping combination comprising a different mapping of said plurality of tokens to said plurality of retrieved financial instrument parameters, said processor to map one or more of said tokens to a retrieved parameter based on at least one potential input pattern corresponding to the retrieved parameter, said processor is configured to assign a plurality of ranks to the plurality of mapping combinations according to one or more ranking criteria, said processor is configured to determine a selected mapping combination from said plurality of mapping combinations based on the plurality of ranks, said processor is configured to determine a plurality of parameter values of the plurality of retrieved financial instrument parameters according to the selected mapping combination, said processor is configured to generate an output defining the financial derivative instrument based on the plurality of parameter values.

3. The system of claim 2, wherein said processor is configured to retrieve from the storage a plurality of potential input patterns corresponding to the retrieved parameter, and to map two or more tokens to the retrieved parameter based on a matching between a pattern of the two or more tokens and a potential input pattern of the plurality of potential input patterns corresponding to the retrieved parameter.

4. The system of claim 2, wherein said processor is configured to determine the identified type based on a pattern of said plurality of tokens.

5. The system of claim 2, wherein the plurality of retrieved financial instrument parameters comprises at least one parameter which is not represented by any of the plurality of input tokens, the processor configured to determine a value of the at least one parameter, and to generate the output defining the financial derivative instrument based on the determined value of the at least one parameter.

6. The system of claim 5, wherein said processor is configured to determine the value of the at least one parameter based on a previous value of said parameter for a previously defined financial derivative instrument.

7. The system of claim 5, wherein said processor is configured to determine the value of the at least one parameter based on a preconfigured value of said parameter.

8. The system of claim 2, wherein the processor is configured to retrieve from the storage a plurality of priority values corresponding to the plurality of retrieved financial instrument parameters, said processor is configured to rank a mapping combination, which maps the plurality of tokens to two or more retrieved parameters based on priority values of the two or more parameters.

9. The system of claim 2, wherein said processor is configured to generate the output defining the financial derivative instrument independent of an order of said tokens within said input sequence.

10. The system of claim 2, wherein said input sequence comprises a single text line comprising said plurality of input tokens.

11. The system of claim 2, wherein said input sequence comprises a voice message including said plurality of input tokens.

12. The system of claim 2, wherein the processor is configured to generate trade information representing a trade of the financial derivative instrument defined based on the input sequence.

13. The system of claim 2, wherein said plurality of financial instrument parameters include one or more of a type parameter, a class parameter, a call parameter, a put parameter, a strike parameter, a trigger parameter, an expiration parameter, an amount parameter, a currency parameter, and a currency pair parameter.

14. A non-transitory machine-readable medium having stored thereon instructions, which when executed by a machine, result in:
storing in a storage parameter information corresponding to a plurality of predefined financial derivative instrument types, the parameter information comprising, for a predefined financial derivative instrument type, a plurality of financial instrument parameters to define the predefined financial derivative instrument type, and, for a parameter of the plurality of financial instrument parameters, a plurality of potential input patterns to define the parameter;
receiving an input sequence including a sequence of a plurality of input tokens; and
based on said input sequence, defining a financial derivative instrument by:
determining, based on said plurality of input tokens, an identified type of the financial derivative instrument to be defined by the input sequence;
accessing said storage, based on the identified type, to retrieve a plurality of retrieved financial instrument parameters corresponding to the identified type;
determining a plurality of different mapping combinations, a mapping combination comprising a different mapping of said plurality of tokens to said plurality of retrieved financial instrument parameters, determining the plurality of mapping combinations comprises mapping one or more of said tokens to a retrieved parameter based on at least one potential input pattern corresponding to the retrieved parameter;
determining a selected mapping combination from said plurality of mapping combinations;
determining a plurality of parameter values of the plurality of retrieved financial instrument parameters according to the selected mapping combination; and
generating an output defining the financial derivative instrument based on the plurality of parameter values.

15. The non-transitory machine-readable medium of claim 14, wherein determining the selected mapping combination comprises:
assigning a plurality of ranks to the plurality of mapping combinations according to one or more ranking criteria; and
determining the selected mapping combination from said plurality of mapping combinations based on the plurality of ranks.

16. The non-transitory machine-readable medium of claim 15, wherein the instructions, when executed, result in:
retrieving from the storage a plurality of priority values corresponding to the plurality of retrieved financial instrument parameters; and
ranking a mapping combination, which maps the plurality of tokens to two or more retrieved parameters based on priority values of the two or more parameters.

17. The non-transitory machine-readable medium of claim 14, wherein determining said identified type of said financial derivative instrument comprises determining said identified type of said financial derivative instrument based on a pattern of said plurality of tokens.

18. The non-transitory machine-readable medium of claim 14, wherein mapping the one or more of said tokens to the retrieved parameter comprises:
retrieving from the storage a plurality of potential input patterns corresponding to the retrieved parameter; and
mapping two or more tokens to the retrieved parameter based on a matching between a pattern of the two or more tokens and a potential input pattern of the plurality of potential input patterns corresponding to the retrieved parameter.

19. The non-transitory machine-readable medium of claim 14, wherein the plurality of retrieved financial instrument parameters comprises at least one parameter which is not represented by any of the plurality of input tokens, the instructions, when executed, result in determining a value of the at least one parameter, and generating the output defining the financial derivative instrument based on the determined value of the at least one parameter.

20. The non-transitory machine-readable medium of claim 19, wherein the instructions, when executed, result in determining the value of said at least one parameter based on a previous value of said parameter for a previously defined financial derivative instrument.

21. The non-transitory machine-readable medium of claim 14, wherein the instructions, when executed, result in defining the financial derivative instrument independent of an order of said tokens within said input sequence.

22. The non-transitory machine-readable medium of claim 14, wherein the instructions, when executed, result in generating trade information representing a trade of the financial derivative instrument defined based on the input sequence.

23. The non-transitory machine-readable medium of claim 14, wherein said plurality of financial instrument parameters include one or more of a type parameter, a class parameter, a call parameter, a put parameter, a strike parameter, a trigger parameter, an expiration parameter, an amount parameter, a currency parameter, and a currency pair parameter.
